(19) United States
(12) Patent Application Publication
(10) Pub. No.: US 2011/0223372 A1
(43) Pub. Date: Sep. 15, 2011

(54) Non-Planar Composite Structural Panel

(75) Inventors: Timothy W. Metz, Bellingham, WA (US); James L. McConnell, Lake Elsinore, CA (US)

(73) Assignee: CSP SYSTEMS, INC., Bellingham, WA (US)

(21) Appl. No.: 12/905,981

(22) Filed: Oct. 15, 2010

Related U.S. Application Data
(63) Continuation-in-part of application No. 11/581,598, filed on Oct. 16, 2006, now abandoned.

(51) Int. Cl. B32B 3/02; B32B 3/12; B32B 37/00

(52) U.S. Cl. 428/80; 428/178; 428/116; 156/242

(57) ABSTRACT

An improved non-planar composite structural panel and method of fabrication are provided. Embodiments of the non-planar composite panel comprise: a first sheet including a first outer surface and a first inner surface; a second sheet spaced apart from the first sheet and including a second outer surface and a second inner surface; a stiffening core element disposed between the first and second sheets and defining a plurality of cells; a rigid foam reinforcing material disposed in the cells; and a mirrored third sheet adhered to the first outer surface of the first concave sheet.

### CROSS-REFERENCE TO RELATED APPLICATIONS

This application is a continuation-in-part application of and claims priority to U.S. application Ser. No. 11/581,598, filed on Jun. 23, 2005, which published as U.S. Patent Application Pub. No. US 2008/0086965, on Apr. 17, 2008, the disclosure of which is incorporated herein by reference in its entirety.

### BACKGROUND OF THE INVENTION

The present invention generally relates to modular structural panels, and more particularly to an improved structural panel, joint, and method of fabricating the same for constructing interconnected panel systems, including curvilinear, arcuate, and convex and concave interconnected panel systems.

Modular building components such as composite structural panels with the ability to be interconnected have been used to construct various types of residential, commercial, and industrial structures. For example, the panels may be interconnected to create walls, floors, ceilings, and partitions of a building or various types of enclosures within a building.

One type of composite panel, commonly known as structural insulated panels (SIPS), has an insulating core that is disposed between an exterior and interior facing sheets. In one method of fabricating a composite panel, a preformed rigid sheet of insulating material such as polystyrene or urethane is sandwiched between the facing sheets. In another type of fabrication used, a light-weight insulating foam is injected between two facing sheets to fill the void between the sheets. Other types of composite structural panels may be uninsulated and have only a structural core or members disposed between the facing sheets to strengthen the panels. The opposing, relatively thin face sheets may be made of metal, fiberglass, plywood, gypsum, oriented strand board, or other materials.

The edges of insulated panels are sometimes formed from only the insulating material or foam itself may form an the edge of the panel, which is abutted directly against a complementary edge of an adjacent panel to create a joint. These types of joints, however, may be weak. It is also known to affix metallic types of edging to sides of the panels having complementary mating tongue-and-groove type arrangements.

The foregoing panels, joints, and methods of fabrication have drawbacks. The panels and/or joints between adjacent panels may lack sufficient strength to resist axial, torsional, or shear loads imposed by the dead weight of the structure, impact forces, or wind loadings. The foregoing known joining methods often are not sufficiently waterproof or airtight, thereby allowing air and water to infiltrate through the joint and into the panel and/or building formed by the panels without an adequate means of intercepting, directing, or stopping the through-flow of these elements. Water infiltration may result in structural damage to the panel or reduce its thermal efficiency by wetting the insulating material. Air infiltration or exfiltration, depending on whether ambient air pressure is greater inside or outside of the structure, results in heat loss and energy inefficiency that translates into higher utility costs for heating and air conditioning. In inclement weather situations, ambient pressure differentials between the exterior or interior of a structure may cause panels to bow and joints to partially or completely open and fail. Existing panel fabrication methods are also often complicated and time-consuming, thereby resulting in higher manufacturing and final product costs.

Accordingly, there remains a need for a composite structural panel, joining system, and method of fabrication that overcomes the foregoing shortcomings of current structural panel systems.

### SUMMARY OF THE INVENTION

The present invention is directed to an improved composite structural panel and joint, and a method of fabricating the same that overcomes the shortcomings of foregoing known panels and joining systems. The invention provides a modular composite structural building panel with increased strength, non-leaking joints, and a unique fabrication process. When combined in a modular system comprising multiple adjacent units coupled together with the joining system disclosed herein, a building or other enclosure may be constructed that is strong, thermally efficient, and weather resistant. Typical applications, without limitation and for illustrative purposes only, may include residential, commercial, and industrial buildings; equipment enclosures; partitions; etc. The invention provides numerous advantages over known panel systems as further described herein.

According to one aspect of the invention, a composite structural panel may generally include a first sheet including a first outer surface and a first inner surface; a second sheet spaced apart from the first sheet and including a second outer surface and a second inner surface; a stiffening core element disposed between the first and second sheets and defining a plurality of cells; and a rigid foam reinforcing material disposed in the cells. In the preferred embodiment, the foam is a rigid urethane foam. In another embodiment, the panel may further include a first longitudinally-extending edge formed between the first and second sheets, the edge including a deformable foam portion protruding outwards from the edge and extending longitudinally along the edge. In one embodiment, the edge may include a longitudinally-extending window and the foam may protrude outwards through the window to form the deformable foam portion. The deformable foam portion may have a convex-shaped surface.

According to one aspect of the invention, a composite structural panel may include a first facing sheet; a second facing sheet spaced apart from the first sheet; a foam material disposed between the first and second sheets; and a first longitudinally-extending edge having a deformable foam portion protruding outwards from the edge and extending longitudinally along the first edge. The deformable foam portion of the first edge is preferably compressible in response to contact by an abutting surface, such as a surface on a second edge of a second panel that may be inserted into the first edge of the first panel. The deformable portion provides a seal that forms a thermal break and air infiltration barrier when two adjacent panels are interconnected at their respective edges. In other embodiments, the deformable portion of the first edge may mate with and be compressed by contact with a second deformable portion on a second edge of a second panel. The first edge may include a longitudinally-extending window and the foam may protrude outwards through the window from inside the first edge and panel to form the deformable foam portion. In one embodiment, the first edge may have a double ship-lap configuration to complement a double ship-lap edge configuration of a mating second panel which may be inserted into the first panel edge.

According to another aspect of the invention, a composite structural panel system is provided that includes a first panel including an internal cavity, an insulating material disposed in the cavity, and a first longitudinally-extending edge having a deformable foam portion protruding outwards from the edge and extending longitudinally along the first edge. The panel system further includes a second panel including a second longitudinally-extending edge configured to complement the first edge and receive the first edge in an interlocking relationship. The deformable portion of the first edge preferably compresses upon contact with the second edge when the second edge is inserted into the first edge to form a seal. In one embodiment, the second edge also includes a deformable foam portion protruding outwards from the second edge and extending longitudinally along the second edge. The deformable foam portions of the first and second edges may be arranged to become mutually engaged with each other and compressed when the first edge is inserted into the second edge to form a foam-to-foam seal. According to another aspect of the invention, a modular composite structural panel system is provided that includes a first panel including a pair of spaced apart sheets each having an outer face and at least one first edge longitudinally-extending between the sheets. The first edge preferably includes an elongated recess and an elongated projection extending along the edge. The panel system further includes a second panel including a pair of spaced apart sheets each having an outer face and at least one second edge longitudinally-extending between the sheets. The second edge preferably includes an elongated recess and an elongated projection extending along the second edge. Preferably, the second edge is configured complementary to the first edge. The first and second edges may be abuttingly interconnected such that the projection of the first edge complementary engages the recess of the second edge and vice-versa to define a joint; the joint including a pressure equalization chamber to balance ambient pressures on opposite faces of the first and second panels. In one embodiment, at least the first edge includes a first deformable foam portion protruding outwards from the first edge and extending longitudinally along the first edge; the deformable portion being compressed by the second edge when the first and second edges are interconnected to form a first seal. The first edge may further include a first longitudinally-extending gasket or sealant, which is compressed by the second edge when the first and second edges are interconnected to form a second seal. In one embodiment, the first and second seals trap air therein when the first and second edges are interconnected and abutted to define the pressure equalization chamber along the panel edges between the first and second seals.

According to another aspect of the invention, an improved method of fabricating a composite structural panel is provided. The method may include applying a thickness of foam to a first sheet held in a substantially horizontal position; setting a core having open cells down into the foam; contacting the core with the first sheet; layering a second sheet onto the core to form a panel; and expanding the foam between the first and second sheets to reinforce to the core. In a preferred embodiment, the foam is a rigid urethane foam. The method preferably further includes restraining the first and second sheets from moving relative to each other before expanding the foam. Preferably, the method includes compacting the foam in the open cells which reinforces the core by expanding the foam against and applying pressure to the walls of the core defining the open cells as the foam expands. The method preferably also includes hardening the foam after the foam has expanded. In another embodiment, the method includes providing pressure to hold the sheets and core together, and heating the panel to cure and harden the foam.

Although the preferred structural panel and system of joined panels may sometimes be described herein with reference to a vertically-oriented wall structure, the invention is not limited in its applicability by such reference. Any reference to either orientation or direction is intended primarily for the convenience in describing the preferred embodiments and is not intended in any way to limit the scope of the present invention thereto. Accordingly, panels and systems according to principles of the present invention may be used without limitation in applications wherein the panels are used as floors, ceilings, or other structures and are oriented in any direction including horizontally or angled or sloped.

Implementations and embodiments of the present invention include a non-planar composite structural panel. More specifically, a composite structural solar panel is provided having: a first concave sheet including a first concave outer surface and a first convex inner surface; a second concave sheet spaced apart from the first concave sheet and including a second convex outer surface and a second concave inner surface; a stiffening core element disposed between the first and second sheets and defining a plurality of cells; a rigid foam reinforcing material disposed in the cells; and a mirrored third sheet adhered to the first concave outer surface of the first concave sheet.

In a further implementation, a method of producing a non-planar composite structural panel is provided, the method comprising: forming a urethane core compatible with a desired curvature; adhering the urethane core to an inner and outer surface skin to form a planar composite panel; forming a non-planar composite panel by restraining the planar composite panel in a non-planar heated fixture; and removing the composite panel from the non-planar heated fixture. The step of forming the urethane core compatible with a desired curvature can further comprise: applying an expandable urethane material to a surface; setting a rigid core element into the expandable urethane material; expanding the urethane material through the rigid core structure; and cutting one or more kerfs into one or more sides of the urethane core.

A still further implementation provides a method of producing a non-planar composite structural panel comprising: forming a urethane core compatible with a desired curvature; adhering the urethane core to an inner and outer surface skin to form a planar composite panel having an inner surface and an outer surface; forming a non-planar composite panel by restraining the planar composite panel in a non-planar heated fixture; removing the composite panel from the non-planar heated fixture such that the non-planar composite panel has a convex inner surface and concave outer surface; and adhering a third material to at least one of the convex inner surface or the concave outer surface, the third material having reflective, optical, insulative or acoustic properties different from that of the non-planar composite panel.

Implementations and embodiments of the present invention may incorporate one or more of the following features. The foam reinforcing material is a rigid urethane foam. The first and second sheets are made of metal. The core element is made of a material selected from the group consisting of paper, resin or polymer impregnated paper, metal, plastic, fiberglass, graphite, and fiber-filled composites. The core element is a rigid or semi-rigid structural member having a plurality of walls defining at least one geometric shape. The geometric shape of the core element is selected from the group consisting of triangular, trapezoidal, rhombus, rectangular, square, diamond, pentagon, hexagon, heptagon, octagon, nonagon, decagon, and circular. The core element defines a honeycomb shape. The inner and outer surface skin has a thickness no greater than 1 inch. The non-planar composite panel is formed by restraining the planar composite panel in a non-planar heated fixture for not longer than 20 minutes at a temperature of not greater than 160 degrees Fahrenheit. The non-planar composite panel is a substantially concave panel. The non-planar composite panel and the adhered third material are restrained in a non-planar heated fixture. The third material is a reflective material adhered to the concave inner surface of the non-planar composite panel. The non-planar composite material withstands a structural load of 200 pounds per square foot without negatively impacting the reflective material. wherein the non-planar composite material with the adhered reflective material is a solar panel.

Implementations of the present invention provide one or more of the following advantages: increased load strength, increased resistance to wind loads; improved optics and reflectivity, shatter resistance, use of thinner third materials including thinner reflective materials, safer handling and transport of reflective surfaces; and increased life-cycle performance.

### BRIEF DESCRIPTION OF THE DRAWINGS

The features of the preferred embodiments will be described with reference to the following drawings where like elements are labeled similarly, and in which:

FIG. 1 is a front view of a preferred embodiment of a composite panel according to principles of the invention with a partial cross-section to show the interior structure of the panel;

FIG. 2 is a top cross-sectional view showing two adjacent panels of FIG. 1 prior to being abutted at the edges to form a joint;

FIG. 3 is a top cross-sectional view showing two adjacent panels of FIG. 1 after being abutted at the edges to form a joint;

FIG. 4 is a perspective view of the panel of FIG. 1 showing an illustrative embodiment of a panel edge;

FIG. 5 is a flow chart of a method of fabricating a non-planar composite material having a desired surface;

FIG. 6A is a top view of an inner or outer skin assembly;

FIG. 6B is a top perspective view of an inner or outer skin assembly with the side walls folded orthogonally to the planar skin surface.

FIG. 7 is a top perspective view of a non-planar solar collecting panel of the present invention.

### DETAILED DESCRIPTION

It is understood that while the present invention will now be described and illustrated for convenience with reference to particular preferred embodiments, the scope of the invention is not limited to such embodiments. Furthermore, the description and drawings of the invention that follow, and any references to orientation, position, configuration, direction, size or materials, are also intended for convenience and does not limit the scope of the present invention.

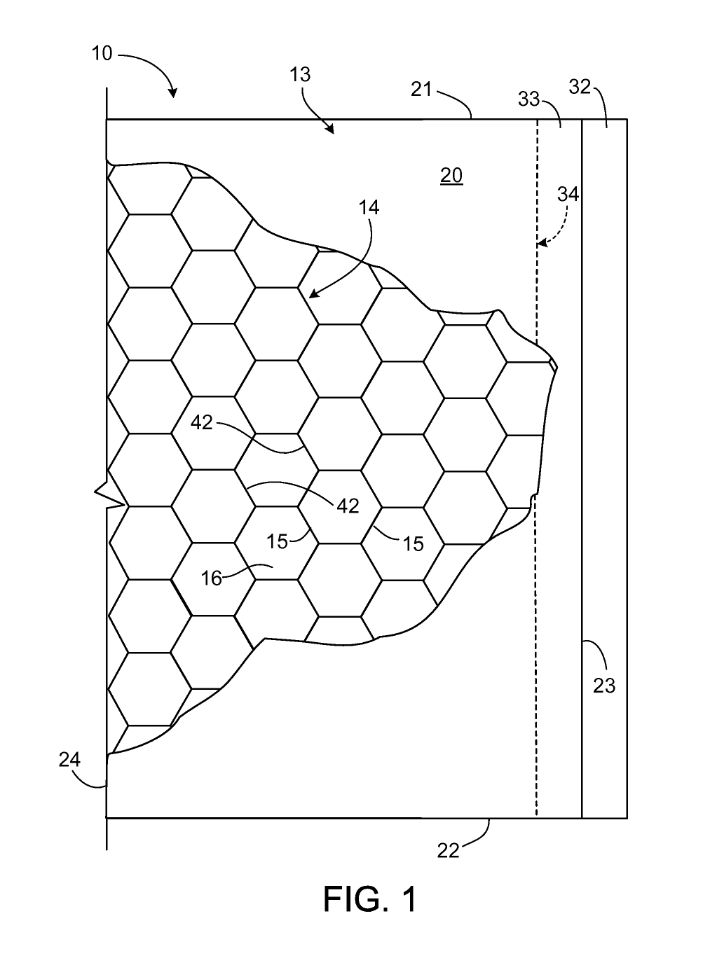

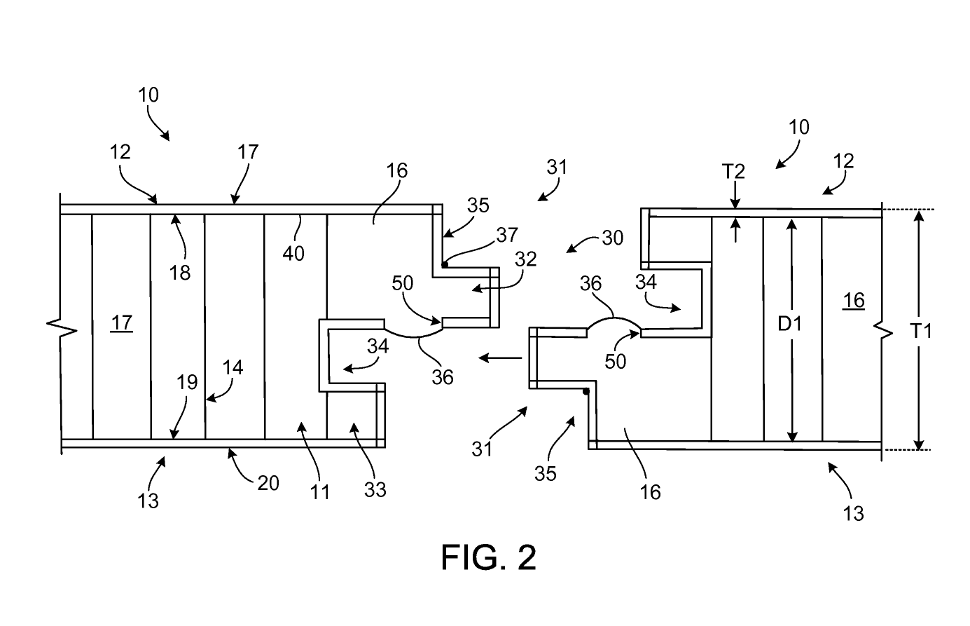

Referring to FIGS. 1 and 2, a composite structural panel 10 generally includes two outer layers such as sheets 12, 13 arranged in substantially facing relationship to each other and an intermediate layer 11 spacing the outer layers apart. In one embodiment, intermediate layer 11 includes a generally rigid stiffening or reinforcing core 14 bonded to outer layers 12, 13 to form a unified composite structure. Core 14 preferably has an open structure defining a plurality of open cells 15 surrounded by cells walls 42. In a preferred embodiment, an insulating material 16 is disposed in and fills at least some of the cells, and more preferably fills substantially all of the cells to strengthen and reinforce core 14 and panel 10 as well as to insulate the panel.

Sheets 12, 13 each generally include an inner surface or face 18, 19, an outer surface or face 17, 20, and four longitudinally-extending and opposing sheet edges extending along each respective sheet. In some embodiments where panels 10 are oriented vertically or sloping, the four sheet edges may be characterized as a generally horizontal top edge 21, an opposing bottom edge 22, and two opposing vertical side edges 23, 24 (see FIG. 1). In one embodiment, sheets 12, 13 may be substantially planar and extend in horizontal and vertical directions. Sheets 12, 13 are preferably arranged in substantially opposing and parallel relationship to each other as shown. In some embodiments, where required by a particular application, sheets 12, 13 may be disposed at an angle to each other to form a panel 10 having a varying thickness from edge to edge. Preferably, sheets 12 and 13 have the same overall dimensions (width, height, and thickness).

The inner and outer surfaces of sheets 12, 13 may be generally smooth or embossed with a pattern for either aesthetic or practical purposes. For example, if sheet 12 or 13 is to be used for flooring, they may be embossed with a non-slip checkering pattern. In addition to being substantially planar or flat, sheets 12, 13 may also include undulating curved ribs, box ribs, corrugations, or other typical cross-sectional shapes commonly used for building panels.

Sheets 12, 13 may be made of any suitable material, including but not limited to ferrous and non-ferrous metals, plastic or polymer, fiberglass, graphite or other fiber composites, plywood, oriented strand board, etc. Suitable metals may include plain steel, galvanized steel, stainless steel, aluminum, etc. In a preferred embodiment, sheets 12, 13 are made of metal, and may have an illustrative typical thickness T2 in the range from about 0.0179 to about 0.0359 inches. It will be appreciated that the type of material used to fabricate the sheets and thickness of the sheets may be varied according to the specific load and design requirements of a particular application. A finish such as paint, epoxy, or other coatings may be applied to the inner and/or outer surfaces of sheets 12 and 13.

Although sheets 12 and 13 may have the same general construction, shape, and size, it will be appreciated that the sheets may differ depending on the intended application for the composite panels. For example, the sheet on the exterior of a building may have different requirements than the sheet facing the interior of the building. Accordingly, panels according to principles of the present invention may be customized to match the intended end use.

With continuing reference to FIGS. 1 and 2, core 14 in one embodiment preferably is a rigid or semi-rigid structural member including a plurality of interconnected walls 42 defining a plurality of open cells 15 formed therein. In some embodiments, the walls 42 may preferably define various shapes including geometric shapes. In one possible embodiment as shown in FIG. 1, core 14 may have a honeycomb shape created by a plurality of interconnected hexagonal units. It will be appreciated, however, that other suitable shaped units such as circular, triangular, trapezoidal, rhombus, rectangular, square, diamond, pentagon, hexagon, heptagon, octagon, nonagon, decagon, and other polygons may be used without limitation depending on the required strength characteristics of the panel so long as open cells 15 are provided. Core 14 abuts sheets 12 and 13 and preferably extends completely therebetween to transfer and evenly distribute external loads between the sheets. Preferably, core 14 may have a relatively rigid structure to reinforce and strengthen panel 10. Core 14 may be made from paper, resin or polymer impregnated paper, metal, plastic, fiberglass, graphite or other fiber-filled composites, etc. depending on the strength requirements of the panel for a particular application. Illustrative typical depths D1 for core 14 defining the panel depth (excluding the thickness of each sheet) as measured from inside of sheet to sheet may range between about 1 to 6 inches in some embodiments. However, the depth of core 14 may be varied above and below the illustrative range according to the strength and insulating properties required for the panel.

In a preferred embodiment, core 14 is reinforced with an insulating material 16 that is disposed in at least some of the open cells 15, and more preferably substantially all of the open cells. Insulating material 16 serves to strengthen and stiffen core 14 to better withstand loads imposed on panel 10 and to thermally insulate the panel. In one embodiment, insulating material 16 is preferably a polymer-based foam, and more preferably a rigid polyurethane foam (commonly also referred to as simply “rigid urethane foam”). Rigid urethane foam provides numerous advantages for use in the construction of panels 10 in contrast to other commercially-available insulating materials sometimes used for insulated panel construction. Rigid urethane foam has one of the highest insulating R-values per inch of commercially available products. Accordingly, with typical values in the range of R 5.6 to R 8 per inch, for example, thinner panels 10 may advantageously be produced using rigid urethane foam while retaining the high insulating efficiency only achievable with thicker panels using some other insulating materials.

In contrast to other insulating materials commonly used in the industry, including flexible urethane foam, rigid urethane foam advantageously has high compressive and shear strengths despite the light-weight characteristics of the rigid foam. This permits panel sheets 12, 13 to have relatively thin overall thicknesses T2 since some of the load-bearing capacity is provided by the strength of the rigid urethane foam. Accordingly, the unique combination of rigid urethane foam with the reinforced core panel construction features and method of fabrication according to principles of the present invention allows panels 10 to be made thinner than with other insulating materials, but advantageously capable of spanning relatively long unsupported distances. In some embodiments, for example, panel 10 may have illustrative typical total thicknesses TI in a range from about 1 to 6 inches for building panels, and a total thickness of between about ¼″ to about 1″ for solar backer panels. Rigid urethane foam is further characterized by advantageous properties such as low vapor transmission, dimensional stability, and moisture resistance. Rigid urethane foam also advantageously has self-adhesive properties allowing it to bond to a variety of substrate materials such as sheets 12, 13 without any additional adhesives or bonding agents.

It should be noted that rigid urethane foam differs from flexible urethane foam in a number of ways. Rigid urethane foam has a closed cell structure, which typically without limitation is in the range of 90% or greater. By contrast, flexible urethane foam has an open cell structure which provides the material with more resiliency and better sound absorption properties than rigid urethane foam. Accordingly, flexible urethane foam is commonly used in cushioning applications (e.g., seating, bedding, carpet padding, etc.) and for acoustic panels. Rigid urethane foam, however, has a higher compressive and shear strength than flexible urethane foam, thereby providing a more rigid or stiff structure capable of better resisting external loads without significant flexing or deformation. Rigid urethane foam has a higher hardness on the Shore A or D scale than a flexible urethane foam. In sum, due to the superior mechanical strength of rigid foam combined with good thermal insulating values, rigid urethane foam is preferred over flexible urethane foam for reinforcing core 14 of panel 10.

Although rigid urethane foam is preferred for use with the present invention, it will be appreciated that other insulating materials including flexible urethane foam may alternatively be used depending on the specific requirements of the intended application. Accordingly, the invention is not limited by the type of insulating material used.

The rigid urethane foam is formed from a two component reactive resin system in which the components expand when mixed together and then hardens as the resins cure. The rigid urethane foam preferably fills cells 15 for the entire depth D1 of the core 14 to optimize reinforcement of the core, and the strength and insulating value of entire panel 10. The urethane foam readily bonds with core 14 and serves to reinforce the core as the foam expands, cures, and hardens. Accordingly, core 14 is essentially embedded in the expanded hardened urethane foam. Advantageously, due to reinforcing core 14 with rigid urethane foam, the core and panel 10 is better able to resist both axial in-plane loads acting on the edge of panel 10 and out-of-plane loads acting normal or perpendicular to the outer surfaces 17, 20 of the panel.

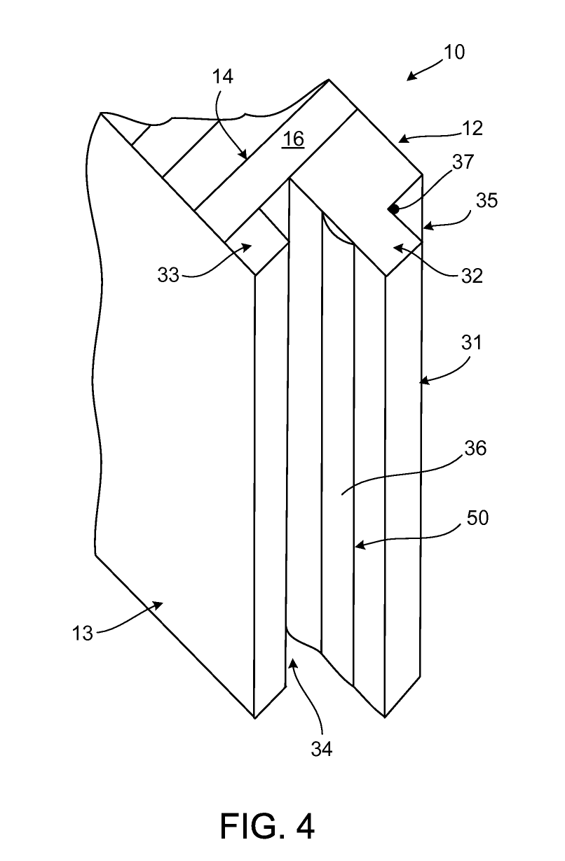

With reference to FIGS. 2-4, at least one longitudinally-extending panel edge 31 is provided on panel 10 which preferably is configured and adapted to mate with a complementary-shaped edge on an adjacent panel, which forms a panel joint 30 when the two adjacent panels are abutted together. Panel 10, however, may include as many edges as required for a particular application to mate with any desired number of corresponding abutting panels. In a preferred embodiment, edge 31 may be configured to form a double ship-lap offset joint as shown and further described herein. Edge 31 may be formed as an integral part of sheet 12 or 13 in one embodiment. For example, in one possible embodiment where sheets 12, 13 are formed of metal, edge 31 may be roll-formed in one-piece as part of sheet 12 and/or 13. In other embodiments, edge 31 may be formed as a separate component that is attached to panels 12 and 13 by any suitable technique known in the art depending on the material from which the panels are fabricated. Accordingly, edge 31 may be attached to the panels by welding, with fasteners, with adhesives, heat fusion for polymers or fiberglass, etc. without limitation.

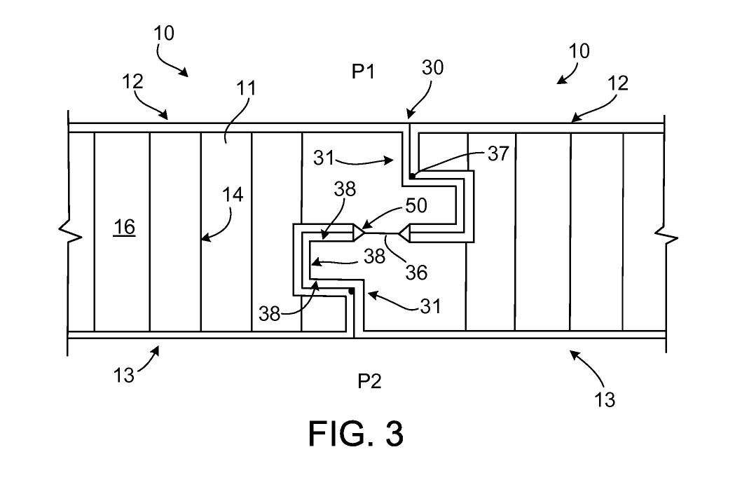

Panel edge 31 defines first and second projections 32 and 33 extending longitudinally along the edge. Panel edge 31 also preferably defines a recess 34 in one embodiment which extends longitudinally along the edge. In one possible embodiment as shown, recess 34 is located between projections 32 and 33. Projection 32 may include a step 35 which is cooperatively designed to fit into a corresponding and mating recess 34 on an abutting panel 10. Since panel edges 31 form a double ship-lap offset joint having an asymmetric shape, it will be appreciated that panel edges 31 on abutting panels 10 are preferably arranged and configured in an opposite orientation such that the projections and recesses in one panel may be received in the projections and recesses of the abutting panel, as shown in FIG. 3.

In a preferred embodiment, panel edge 31 preferably also includes a longitudinally-extending flexible or deformable portion that serves as a primary joint seal and means for locking two adjacent panels together. In one possible embodiment, as shown in FIGS. 2-4, the flexible portion may be a configured as convex surface 36 which extends longitudinally along panel edge 31. As shown in FIG. 3, convex surface 36 is preferably arranged on the panel edge 31 so that a pair of opposing convex surfaces become mutually aligned and engaged with each other when two panels 10 are joined together. The convex surfaces 36 on each of panels 10 deform and are compressed when mutually engaged to lock the panels together by a friction fit.

In a preferred embodiment, convex surface 36 is formed by providing a longitudinally-extending window 50 in edge 31 so that the insulating material 16 may protrude through the window and above the surface of recess 34 with a generally convex or arcuate shape. In some illustrative embodiments, window 50 preferably may be at least ½-inch wide, and more preferably at least ¾-inch wide. Since the mating convex surfaces 36 are both formed of insulating material 16, the surfaces advantageously also form and provide a thermal break and air infiltration barrier in addition to serving the function of locking the panel together. Because convex surface 36 is preferably formed as an integral part of insulating material 16 itself, as opposed to being a separate component that must be affixed to edge 31, fabrication of the convex surface is economical and the convex surface is inherently strong being an integral part of a larger mass of insulating material disposed within panel 10. It is contemplated that in other possible embodiments, however, convex surface 36 may alternatively be formed as a separate component that is affixed to panel edge 31.

Joint 30 further includes a secondary sealant or gasket 37 which extends longitudinally along panel edge 31 as shown in FIGS. 2-4. Preferably, sealant or gasket 37 is disposed on each side of the convex surface 36, and more preferably is located in a corner of step 35. When two adjacent panels 10 are joined together, projections 33 engage and compress sealant or gasket 37 to form a seal. Any suitable commercially-available gasket or sealant material may be used. For example, sealants may include without limitation silicon or vinyl caulking in which case a bead of caulk is run longitudinally along panel edge 31. Suitable gasket materials may include without limitation rubber, neoprene, polymers, natural or synthetic fabrics, etc.

A pressure equalization chamber 38 may be formed by panel edge 31 on either side of convex surface 36 between the convex surface and sealant or gasket 37 when two adjacent panels 10 are abutted together to form joint 30. Pressure equalization chamber 38 acts as an air lock trapping air therein and functions to offset unbalanced ambient pressures P1 and P2 on either side of joint 30 to help prevent partial or complete opening and failure of the joint if the pressure differential becomes unduly large across the joint. For example, if P1 and P2 represent exterior and interior building pressures, respectively, the effect of wind or storm conditions on outer face 17 of sheet 12 would create a greater pressure P1 than P2. This would flex panels 10 and tend to bow joint 30 towards the interior of the building if not properly supported by the building superstructure. Pressure equalization chamber 38 compensates for the pressure differential across joint 30 to help protect the integrity of the joint and panels 10.

A preferred method of fabricating panel 10 will now be described. In the preferred embodiment, panels 10 are made with rigid urethane foam as the insulating material 16. Preferably, the rigid urethane foam is made using a two component reactive system in which two urethane base resins are mixed together, undergo a chemical reaction, and expand during the reaction. A restrained rise process is preferably used with the rigid urethane foam to fabricate panel 10. In contrast to the free rise foam process wherein foam is allowed to rise freely and increase in volume, the restrained rise process constrains the maximum volume that the foam can reach as it expands. This results in good compaction of the foam and ensures the panel is thoroughly filled with foam to the greatest extent practicable.

The panel fabrication process begins by manufacturing the facing sheets 12, 13 with the required dimensions by any suitable technique known in the art depending on the specific type of material used. Where sheets 12, 13 are made of metal, such as steel or aluminum for example, the process may include forming the sheets by roll forming. At least one of the sheets 12, 13 is preferably rolled formed to include panel edge 31 with the double ship-lap offset joint configuration described herein. In other possible embodiments, sheets 12, 13 may be thermal formed or extruded if made of plastic.

In the next step of the panel fabrication process, one of the sheets 12, 13 is selected to be a bottom sheet that is positioned horizontally within a fixture or form that generally approximates the final size (i.e., thickness, width, and length) intended for the finished panel 10. The fixture or form helps to ensure that the foam is contained therein. Assuming for convenience of description only that sheet 12 is the one used in this step, sheet 12 is oriented so that outer surface 17 is facing downwards and inner surface 18 is facing upwards. An adhesive 40 is next applied to inner surface 18 to help bond core 14 to sheet 12 in a subsequent step and ensure the structural integrity of the panel 10. It should be noted, however, that the adhesive application step is optional and need not be used to fabricate panel 10. Particularly if rigid urethane foam is employed, which by its chemical properties bonds somewhat like an adhesive to surfaces in contact with the foam, the adhesive step may be omitted without adversely affecting structural integrity to panel 10. However, the adhesive step is preferably used with rigid urethane foam as an added measure of precaution.

The two component rigid urethane foam base resins are next mixed together which begins a chemical reaction to form the foam. Preferably, the foam base resin mixture is then applied to inner surface 18 of bottom sheet 12 (on top of adhesive 40) concurrently with or immediately after the two base resin components are mixed since the foam will begin to form and expand upon mixing the two resins. The rigid urethane foam is filled to a sufficient depth on bottom sheet 12 so that after the foam completes its expansion, the height of the foam will reach the desired depth D1 of panel 10.

After the rigid urethane foam has been added to bottom sheet 12, core 14 is next lowered and set into the foam and on top of sheet 12 before the foam hardens and is still flowable. Preferably, core 14 contacts inner surface 18 of sheet 12 and adhesive 40 previously applied thereto. As core 14 is lowered into the foam, the foam comes up through and completely fills open the open cells 15 of the core. Advantageously, this approach ensures good penetration of the foam into open cells 15 to provide maximum reinforcement of core 14.

Top panel 13, which may or may not have adhesive 40 applied to inner surface 19, is set down on top of and into contact with core 14. Outer surface 20 of panel 13 is thus facing upwards and outwards. The various components of soon-to-be finished panel 10 are now all in place; however, the rigid urethane foam has not stopped expanding and is not as of yet completely cured.

Partially finished panel 10 is preferably next placed in a commercially-available laminator or similar fixture that provides heat to finish curing the rigid urethane foam and provides pressure to hold the panel components together against the force of the expanding foam. Expanding rigid urethane foam may exert typical forces of about 17,000 lbs in a 4′ wide by 10′ long panel, which would otherwise force the panel components apart if not restrained by some means until the foam cures and stops expanding. Accordingly, the laminator or other fixture that may be used has structural members which serve as clamps to restrain the sheets and assembled panel components so as to prevent them from moving excessively while the foam expands. This also keeps the panel sheets positioned to achieve the final intended dimensions for the panel (e.g., panel total thickness T1) and is known as a restrained rise process. Advantageously, as the expanding foam exerts pressure within core 14, the foam pressure acting on cell walls 42 tightly compacts the foam within open cells 15 thereby tightly embedding the core within the foam to provide substantial structural reinforcement of the core. Core 14 essentially becomes an integral component of the rigid urethane foam that allows the core and panel 10 to better withstand external loads and forces than other panel constructions known in the art, thereby creating a very strong, yet light-weight structural composite panel.

Depending on quantity of panels required for a specific project, a continuous laminator that works in a conveyor-like manner or a platen laminator/press in which a plurality of panels may be vertically stacked on top of each other may be used. However, it should be noted that the invention is not limited to the use of any particular type of laminator.

Preferably, convex surface 36 may conveniently be formed on panel edge 31 during the foregoing process by placing an adhesive-backed tape over window 50 before the foam is applied to the panel. As the foam expands, it will force the tape to bulge and the foam will protrude slightly above the surface of recess 34, thereby forming convex or arcuately-shaped surface 36. Since convex surface 36 is formed during the basic panel fabrication process and does not require a separate step, the cost of forming the convex surface is negligible. It will be appreciated that convex surface 36 may be formed by other techniques or as a separate component that is subsequently affixed to panel edge 31. Accordingly, the invention is not limited to the preferred method of making convex surface 36.

In a further implementation of the present invention non-planar, curvilinear, concave or convex composite structural panels can be fabricated using one or more composite panels.

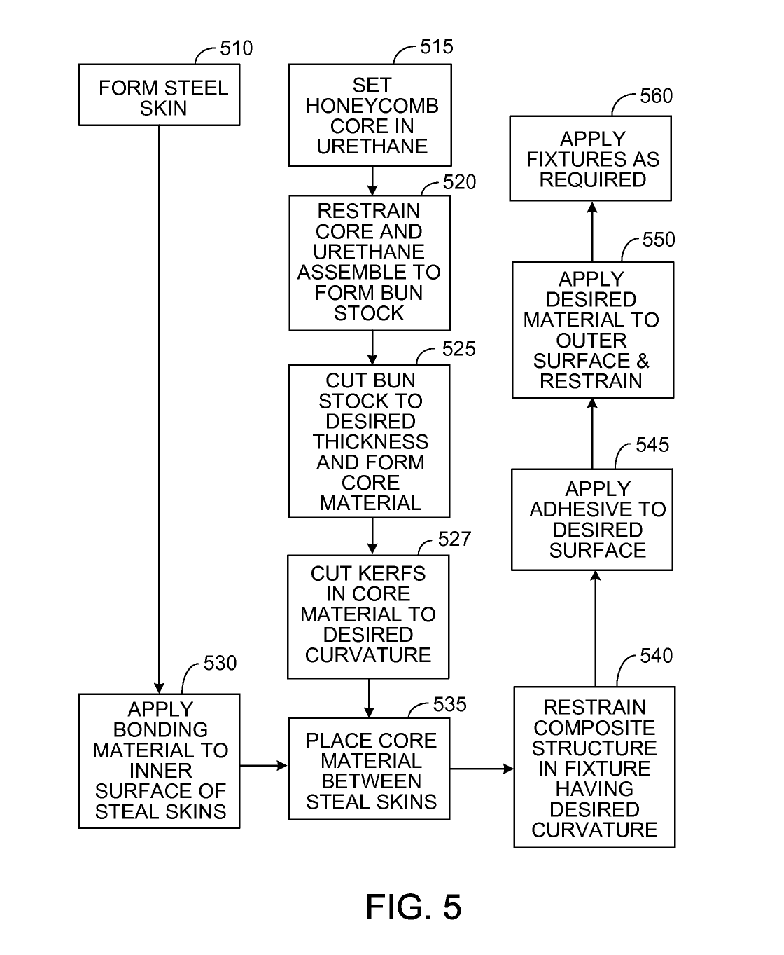

With reference to FIG. 5, a method 500 of forming a non-planar composite panel comprises: forming the inner and outer skins of the panel (510) to receive the assembled honeycomb core or bun stock; forming the bun stock core by: setting a honeycomb core in an expanding urethane material (515); restraining the core and urethane assembly to form the bun stock (520); cutting and shaping the bun stock to the desired dimensions (525); cutting kerfs in the bun stock according to the desired curvature (527); applying an adhesive to the inner surfaces of the inner and outer skins (530); adhering the core material to inner surfaces of the inner and out skins (535); and restraining the composite panel in a heated fixture having the desired curvature (540). The method 500 can further include steps to adhere a desired surface, such as a reflective surface, to the assembled non-planar composite panel. An adhesive is applied to the desired surface (545); the desired ornamental, architectural, or functional surface material is adhered to the desired surface of the composite panel and restrained in a heated fixture having in the desired shape (550). After removal from the heated fixture, additional hardware, such as studs, joints, connecting points, and the like can be further adhered to the composite panel (560).

In an implementation the honeycomb core, or bun stock, of the composite panel is formed by depositing the expandable urethane material described above onto a flat surface. The rigid or semi-rigid core comprising a plurality of open cells formed therein, such as a honeycomb structure, is lowered or otherwise placed into the urethane material. The rigid or semi-rigid core structure or core material can be made of any suitable material including paper, metal, plastic, fiberglass, graphite or other fiber-filled composites, etc. depending on the strength requirements of the panel for a particular application.

The combined expandable urethane and honeycomb core is then restrained for a time period of between 1 minute and 1 hour (e.g., less than 60 minutes, less than 50 minutes, less than 40 minutes, less than 30 minutes, less than 20 minutes, less than 15 minutes, less than 10 minutes, less than 5 minutes). The combined expandable urethane and honeycomb core is restrained for a specified time at a temperature greater than ambient temperatures but less than 160 degrees Fahrenheit (e.g., less than 160, 150, 140, 130, 120, 110, 100, 90 degrees Fahrenheit). In embodiments the density of the foam after expansion is between 2.0 and 10.0 pounds per cubic foot, or greater.

The bun stock is then cut to the desired thickness, length and width so as to be compatible with the inner and outer skins of the composite panel. In implementations, kerfs, grooves, detents or recessions are cut into the bun stock according to the desired curve of the finished composite panel. The kerfs can have a thickness of not greater than 1 inch (e.g, 1 inch or less, ¾ inch or ½ inch or less, ¼ inch or less, ⅛ inch or less, 1/16 inch or less, 1/32 inch or less) and a depth into the bun stock of 1 inch or less (e.g., 1 inch or less, ¾ inch or ½ inch or less, ¼ inch or less, ⅛ inch or less, 1/16 inch or less, 1/32 inch or less). In implementations 1 or more kerfs are cut into the bun stock in a generally parallel direction to the desired curve. For example, the kerf is cut across the curve along the contours of the curve of the finished panel. Multiple kerfs can run generally parallel to each other. Kerfs should generally align with corresponding notches in the skin panels as described below.

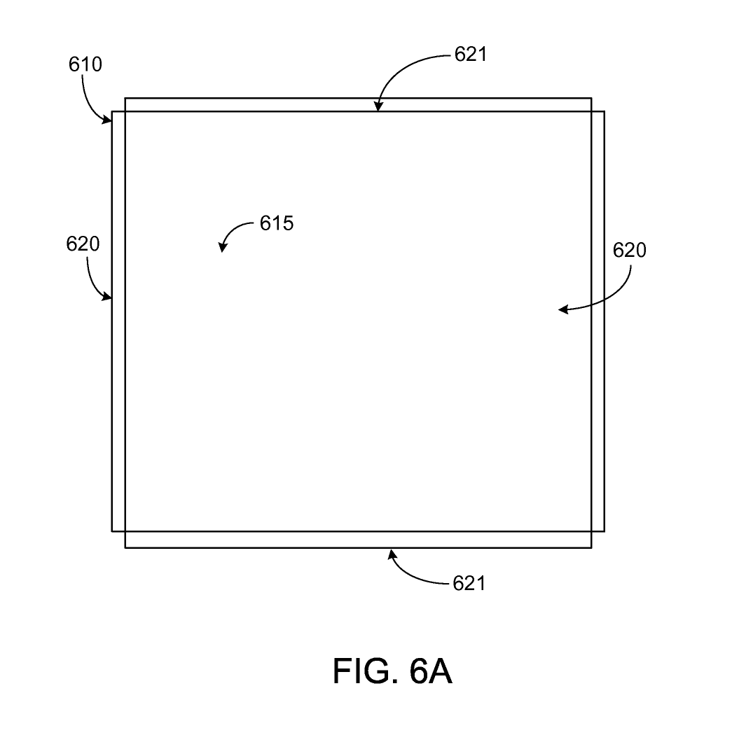

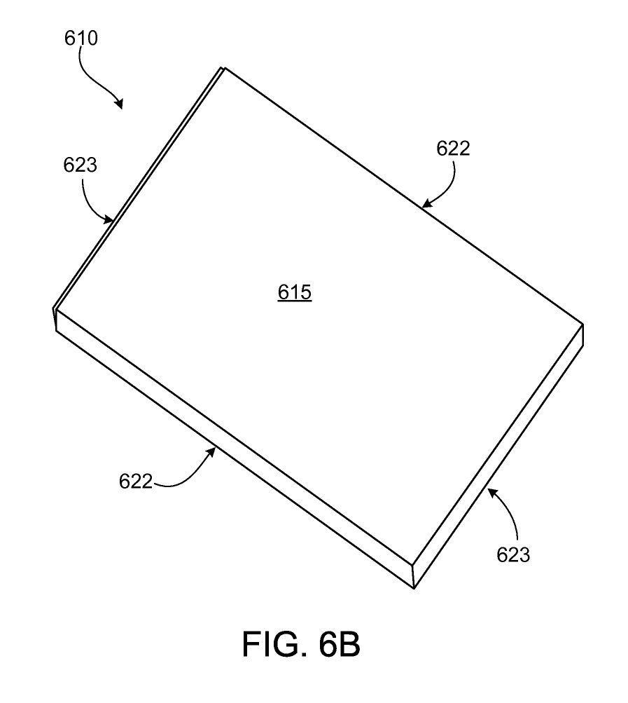

The inner and outer skins of the panel can be of any suitable material, as described above including but not limited to ferrous and non-ferrous metals, plastic or polymer, fiberglass, graphite or other fiber composites, plywood, oriented strand board, etc. Suitable metals may include plain steel, galvanized steel, stainless steel, aluminum, etc. FIG. 6A illustrates an exemplary skin assembly 610 comprising planar surface 615 and side tabs 620 and 621. In forming the skin assembly to receive the core material, side tabs 620 and 621 are folded orthogonally to planar surface 615 thereby forming a lid type structure, as illustrated in FIG. 6B, having a planar surface 620 and sidewalls 622 and 623. Opposing side panels 621 and 622 can be notched to accommodate the desired curvature and bend of the side wall during formation of the non-planar panel. The notches in the side walls can be aligned with kerfs formed in the core material.

With a completed bun stock cut to the appropriate thickness, length and width, and appropriate kerfs according to the desired curvature, and the inner and outer skins formed into lid type structures, an adhesive is applied to the inner surface of the inner and outer skins That is, an adhesive is applied to the portion of the planar surface 620 of the inner and outer skins of the composite panel. The adhesive can be compatible with the expandable urethane material of the bun stock. The adhesive can be a one part moisture cured urethane bonding medium, such as HB Fuller UR 0218 WF.

After the adhesive is applied to the inner surfaces of the inner and outer skins, the properly sized bun stock is sandwiched between the inner and outer skins and made to contact the adhesive lined inner surface of the two skins. This composite assembly is then placed in a heated restraining fixture that is shaped to the desired curvature. The composite assembly is kept in the restrained fixture for a specified time period of between about 1 minute and about 1 hour (e.g., less than 60 minutes, less than 50 minutes, less than 40 minutes, less than 30 minutes, less than 20 minutes, less than 15 minutes, less than 10 minutes, less than 5 minutes). The composite assembly is restrained for a specified time at a temperature greater than ambient temperatures but less than 160 degrees Fahrenheit (e.g., less than 160, 150, 140, 130, 120, 110, 100, 90 degrees Fahrenheit).

After removal of the composite panel from the pre-curved restraining fixture, the process of forming the non-planar composite assembly is complete. It will be appreciated that any number of non-planar configurations are contemplated, including, but not limited to, single curved panels, multiple curved panels, S-curved panels, curvilinear panels, archuate panels, concave panels, and convex panels.

It will further be appreciated that multiple non-planar panels can be combined in any manner to form a larger non-planar surface. In embodiments, the joint assembly described above can be incorporated into one or more sides of the composite panel to enable the combination and joining of multiple non-planar panels. Non-planar panels can also be combined or joined with planar panels, also using the joint assembly described above.

In some implementations, an architectural, ornamental or functional surface material can be further applied to one or more desired surfaces of the non-planar composite panel. For example, acoustic absorbing or reflecting material can be applied to a desired panel. RADAR absorbing or reflecting material can be applied to a desired surface of the non-planar composite panel. Fire retardant or fire resistant material can be applied to a desired surface of the non-planar composite panel. Thermal insulating material can be applied to a desired surface of the non-planar composite panel. Corrosive resistant material can be applied to a desired surface of the non-planar composite panel. In some implementations, a mirrored or reflective surface or other optical material can be applied to a desired surface of the non-planar composite panel. In some implementations the mirrored surface can have a thickness of less than 2.5 mm (e.g. less than 2.5 mm, 2.0 mm, 1.5 mm, 1.0 mm, 0.9 mm, 0.8 mm, 0.7 mm, 0.6 mm, 0.5 mm, 0.4 mm, 0.3 mm, 0.2 mm, 0.1 mm, 0.075 mm, or 0.005 mm).

In implementations, after the non-planar composite panel is formed to the desired curvature, an adhesive can be applied to one or more desired surfaces. The adhesive can be the same as used previously to adhere the bun stock to the inner surface of the inner and outer skins. The adhesive can be chosen to be compatible with both the material of the inner and out skin and that of the surface material to be applied to the non-planar composite panel.

The desirable surface material is then applied over the adhesive and to the desired surface of the non-planar composite panel. The desire surface material and the non-planar composite material are then maintained in a heated restraint having the desired curvature for a time period and temperature profile appropriate to the desired surface material and the adhesive. The non-planar composite panel with the adhered desired material can be restrained for a specified time period of between about 1 minute and about 1 hour (e.g., less than 60 minutes, less than 50 minutes, less than 40 minutes, less than 30 minutes, less than 20 minutes, less than 15 minutes, less than 10 minutes, less than 5 minutes) and at a temperature greater than ambient temperatures but less than 160 degrees Fahrenheit (e.g., less than 160, 150, 140, 130, 120, 110, 100, 90 degrees Fahrenheit).

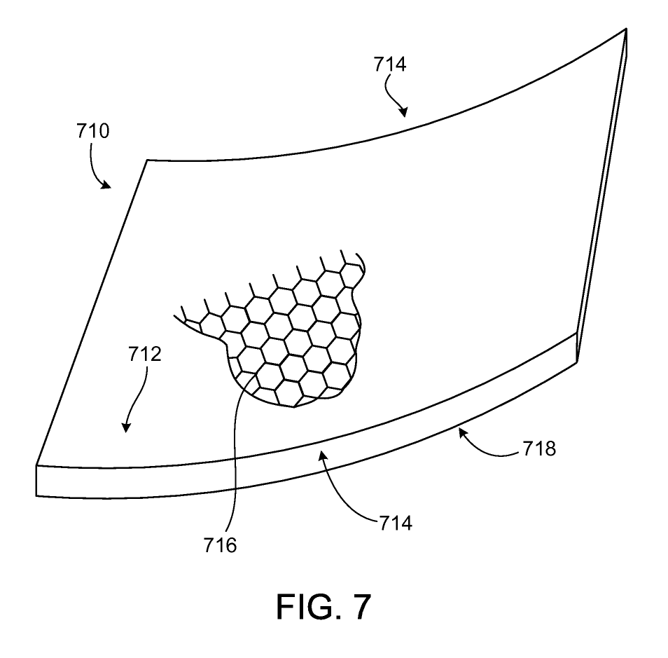

FIG. 7 illustrates a concave, non-planar composite structural panel 710 consistent with the present invention having a mirrored surface 712 adhered to the inner concave surface 714 of the panel. Inner concave surface 714 below mirrored surface 712 is also the outer concave surface of a first outer skin of the composite panel. Inner rigid stiffening core and foam 716 is shown in cut away form. Core 716 is sandwiched between the first outer skin and the second outer skin of the composite panel. The Second outer skin includes convex outer surface 718.

It has been found that concave structural panels having an adhered thin mirror on the inner concave side such as implementations of the present invention can withstand increased structural loads such as wind loads without affecting the desired curvature of the panel and without damage to the mirror surface. The breakability of the mirrored panel is also reduced to near zero. Without being bound by theory, the breakability is reduced due to the force distributing properties of the layered and composite structure of the non-planar panel. With a near zero breakability, shattering of the mirror is not a factor in implementation of the present invention. Thin materials used on the non-planar structural panel other than reflective or mirrored sheets also exhibit similar force distribution properties. Force distribution properties of composite structural panels having rigid core elements filled with urethane foam are generally described in U.S. Patent Application Publication No. US 2008/0095958, the disclosure of which is incorporated by reference in its entirety.

### EXAMPLE

A non-planar, concave composite solar panel comprises a concave composite solar panel backing and a form fitting mirror on the concave surface of the solar panel backing. The composite solar panel is fabricated by forming an inner and outer skin of 26 ga (0.0179″) G90 galvanized steel into lid like structures. The inner and outer skins have a planar surface having dimensions of approximately 65″×67″. Side walls are formed on the edges of the skin's planar surface. The side walls are formed by folding first side tabs having dimensions of approximately 0.31″×65″ orthogonally from the skin's planar surface. Second side tabs having dimensions of approximately 0.31″×67″ are also folded orthogonally from the skins planar surface and in the same direction as the first side tabs. Two or more of the side tabs forming the side walls are notched with grooves spaced no closer than 1.0″ apart and no further than 6.0″ apart. The exact placement of the notches is dependent on the desired curvature of the completed composite panel. At least some of the notches align with kerfs or grooves formed in bun stock. The side of the skin's planner surface that is bounded by the side tabs forming the side wall is referred to as the inner side of the skin. The inner side of the skin can be smooth, etched or otherwise surfaced to promote adhesion to the honeycomb core.

The honeycomb core is formed by applying an expandable urethane material to a horizontal surface. A rigid or semi-rigid structure in the shape of a honeycomb is place on top of the expandable urethane material and the combine urethane and honeycomb structure is restrained between two flat surfaces for no more than 15 minutes at a temperature of no more than 120 degrees Fahrenheit. This allows the foam to expand through the open spaces of the honeycomb structure. The density of the foam after expansion and after the restraining step is between about 2.0 and about 8 pounds per cubic foot. The combined urethane and honeycomb panel is referred to as bun stock.

The bun stock is cut to the desired thickness so that in combination with the inner and outer skins the overall thickness is approximately 0.5 inches. The bun stock is also cut to appropriate length and width such that it fits tightly in the 65″×67″ dimensions of the inner surface of the inner and outer skins.

Because the planar bun stock will be bent to a final curved position, kerfs or grooves are cut on either or both of the inner or outer surface of the bun stock. The kerfs are no more than 0.25″ in thickness and no more than 0.75″ in depth. Each kerf is spaced not less than 1.00″ on center from adjacent kerfs and no more than 6.00″ on center from adjacent kerfs. The spacing is dependent on the amount of curvature required. The kerfs are generally parallel to each other and parallel to the direction of the curve. Each of the multiple kerfs align with a notch in one of the side panels in the side walls.

A one part moisture cured urethane bonding medium, such as HB Fuller UR 0218 WF is applied to the inner surface of each of the inner and outer skins. The fitted and kerfed bun stock is sandwiched between the inner and outer skins to form a planar composite panel. The planar composite panel is then placed in a heated restraining fixture, such fixture having the desired curvature to form the non-planar composite panel. The composite panel is maintained in the heated fixture for no more than 20 minutes at a temperature of no more than about 160 degrees Fahrenheit. Upon removal from the heated fixture, the composite panel has the desired curvature and non-planar form. For use in solar panel arrays, the non-planar composite panel has a concave form on the composite panel inner surface and a convex form on the composite panel outer surface.

The one part moisture cured bonding medium is applied to the concave inner surface of the non-planar composite panel. A 0.95 mm thick flat mirror is then adhered to the concave inner surface of the non-planar composite panel before the bonding medium begins to expand. The non-planar composite panel with the adhered mirror on the inner surface is then again placed in a heated restraining fixture having the desired curvature. The non-planar, mirrored composite panel is maintained in the heated fixture for no more than 20 minutes at a temperature of not more than 160 degrees Fahrenheit.

After removal of the non-planar, mirrored composite panel, fixtures, such as studs, connecting eyes and pads, and other structural connections can be adhered to the convex outer surface or the side walls.

The 0.5 inch thick non-planar composite panel with an adhered 0.95 mm thick mirror on the inner concave side can withstand a structural load of 200 pounds per square foot without affecting the desired curvature of the panel and without damage to the mirror surface. This is equivalent to a wind load of approximately 275 miles per hour to 280 miles per hour. This also reduces the breakability of the mirrored panel to near zero as the mirrored panel will not shatter if struck by an object. As such, flying debris and shards do not form missile hazards that threaten other mirrored panels in a solar panel array.

While the foregoing description and drawings represent the embodiments of the present invention, it will be understood that various additions, modifications and substitutions may be made therein without departing from the spirit and scope of the present invention as defined in the accompanying claims. In particular, it will be clear to those skilled in the art that the present invention may be embodied in other specific forms, structures, arrangements, proportions, sizes, and with other elements, materials, and components, without departing from the spirit or essential characteristics thereof. One skilled in the art will appreciate that the invention may be used with many modifications of structure, arrangement, proportions, sizes, materials, and components and otherwise, used in the practice of the invention, which are particularly adapted to specific environments and operative requirements without departing from the principles of the present invention. The presently disclosed embodiments are therefore to be considered in all respects as illustrative and not restrictive, the scope of the invention being defined by the appended claims, and not limited to the foregoing description or embodiments.

Other implementations and features are within the scope of the following claims:

What is claimed:

1. A composite structural solar panel comprising:
a first sheet including a first concave outer surface and a first convex inner surface;
a second sheet spaced apart from the first sheet and including a convex second outer surface and a second concave inner surface;
a stiffening core element disposed between the first and second sheets and defining a plurality of cells;
a rigid foam reinforcing material disposed in the cells;
and a reflective third sheet adhered to the first concave outer surface of the first sheet.

2. The panel of claim 1, wherein the foam reinforcing material is a rigid urethane foam.

3. The panel of claim 1, wherein the first and second sheets are made of metal.

4. The panel of claim 1, wherein the core element is made of a material selected from the group consisting of paper, resin or polymer impregnated paper, metal, plastic, fiberglass, graphite, and fiber-filled composites.

5. The panel of claim 1, wherein the core element is a rigid or semi-rigid structural member having a plurality of walls defining at least one geometric shape.

6. The panel of claim 5, wherein the geometric shape is selected from the group consisting of triangular, trapezoidal, rhombus, rectangular, square, diamond, pentagon, hexagon, heptagon, octagon, nonagon, decagon, and circular.

7. The panel of claim 1, wherein the core element defines a honeycomb shape.

8. The panel of claim 1 wherein the reflective third sheet is a mirror having an average thickness of less than 1 mm.

9. A method of producing a non-planar composite structural panel comprising:
forming a urethane core compatible with a desired curvature;
adhering the urethane core to an inner and outer surface skin to form a planar composite panel;
forming a non-planar composite panel by restraining the planar composite panel in a non-planar heated fixture;
removing the composite panel from the non-planar heated fixture.

10. The method of claim 8 wherein forming the urethane core compatible with a desired curvature further comprises:
applying an expandable urethane material to a surface;
setting a rigid core element into the expandable urethane material;
expanding the urethane material through the rigid core structure;
cutting one or more kerfs into one or more sides of the urethane core;

11. The method of claim 8, wherein the urethane core comprises a core element having a rigid or semi-rigid structural member comprising a plurality of walls defining at least one geometric shape.

12. The method of claim 8, wherein the urethane core comprises a core element made of a material selected from the group consisting of paper, resin or polymer impregnated paper, metal, plastic, fiberglass, graphite, and fiber-filled composites.

13. The method of claim 8 wherein the inner and outer surface skin comprises a metallic material.

14. The method of claim 8 wherein the inner and outer surface skin has a thickness no greater than 1 inch.

15. The method of claim 8, wherein the non-planar composite panel is formed by restraining the planar composite panel in a non-planar heated fixture for not longer than 20 minutes at a temperature of not greater than 160 degrees Fahrenheit.

16. The method of claim 8 wherein forming the non-planar composite panel forms a substantially concave panel.

17. A method of producing a non-planar composite structural panel comprising:
forming a urethane core compatible with a desired curvature;
adhering the urethane core to an inner and outer surface skin to form a planar composite panel having an inner surface and an outer surface;
forming a non-planar composite panel by restraining the planar composite panel in a non-planar heated fixture;
removing the composite panel from the non-planar heated fixture such that the non-planar composite panel has a convex inner surface and concave outer surface; and
adhering a third material to at least one of the convex inner surface or the concave outer surface, the third material having reflective, optical, insulative or acoustic properties different from that of the non-planar composite panel.

18. The method of claim 16 further comprising: restraining the non-planar composite panel and the adhered third material in a non-planar heated fixture.

19. The method of claim 16 wherein the third material is a reflective material adhered to the concave inner surface of the non-planar composite panel.

20. The method of claim 18 wherein the non-planar composite material withstands a structural load of 200 pounds per square foot without negatively impacting the reflective material.

21. The method of claim 18 wherein the non-planar composite material with the adhered reflective material is a solar panel.
